(19) United States
(12) Patent Application Publication
(10) Pub. No.: US 2004/0223066 A1
(43) Pub. Date: Nov. 11, 2004

(54) Camera having header data indicative of a camera funciton embedded with actual image data for synchronizing the camera function and image data

(75) Inventor: Steven M. Bryant, Holley, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/431,315

(22) Filed: May 7, 2003

(51) Int. Cl. H04N 5/335

(52) U.S. Cl. 348/308

(57) ABSTRACT

A CMOS sensor includes a plurality of pixels for capturing image pixel data; an analog-to-digital conversion mechanism for converting pixel data; one or more first control registers for storing configuration information used for controlling sensor operation; digital data control bus interface for transporting modified configuration information; a digital image data bus interface for sending image header data and image pixel data, wherein the image header data is formed from one or more of the first control registers that contain settings that were used in capturing the image pixel data; and digital circuitry that coordinates with the one or more control registers synchronization between configuration information in the control registers, image pixel data and image header data.

### FIELD OF THE INVENTION

The invention relates generally to the field of CMOS sensors and, more particularly, such CMOS sensors having additional header information included with the image data for identifying captured frame characteristics, such as width, height, strobe, exposure and the like.

### BACKGROUND OF THE INVENTION

Digital cameras include image sensors having photosensitive areas for capturing the incident light that forms an electronic representation of an image therein. The image data is passed to a processor for subsequent processing and eventually storage in a memory device. Often, the camera includes different modes of operation; for example, different resolutions, strobe settings and the like. It is desirable for the processor to know what the particular settings are for an image.

Consequently, a need exists for a camera that matches the image and particular setting.

### SUMMARY OF THE INVENTION

The present invention is directed to overcoming one or more of the problems set forth above. Briefly summarized, according to one aspect of the present invention, the invention resides in a CMOS sensor comprising (a) a plurality of pixels for capturing image pixel data; (b) an analog to digital conversion mechanism for converting pixel data; (c) one or more first control registers for storing configuration information used for controlling sensor operation; (d) digital data control bus interface for transporting modified configuration information; (e) a digital image data bus interface for sending image header data and image pixel data, wherein the image header data is formed from one or more of the first control registers that contain settings that were used in capturing the image pixel data; and (f) digital circuitry that coordinates with the one or more control registers synchronization between configuration information in the control registers, image pixel data and image header data.

These and other aspects, objects, features and advantages of the present invention will be more clearly understood and appreciated from a review of the following detailed description of the preferred embodiments and appended claims, and by reference to the accompanying drawings.

### Advantageous Effect Of The Invention

The present invention has the advantage of allowing a programmable processor to modify the register settings of the digital imager and to synchronize the resulting image data for which the registers take effect.

### BRIEF DESCRIPTION OF THE DRAWINGS

FIG. 1 is a block diagram of the image sensor of the present invention; and

FIG. 2 is a digital camera for illustrating a typical commercial embodiment for the image sensor of FIG. 1.

### DETAILED DESCRIPTION OF THE INVENTION

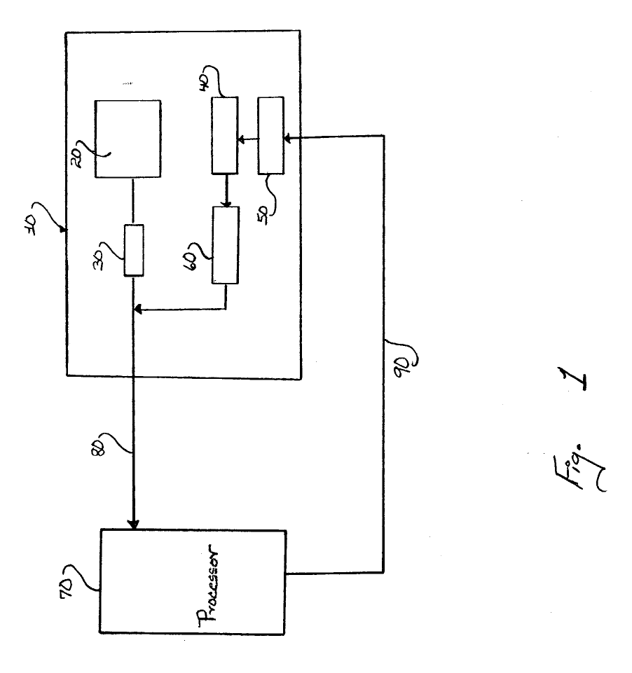

Referring to FIG. 1, there is shown a diagram of the present invention. An image sensor (digital imager) 10 includes a plurality of pixels 20 for receiving incident light which forms an electronic representation of an image and a plurality of pixel value holding sites (not shown) respectively beside each pixel where each pixel value can be held until read out by control circuitry. This permits pixel values corresponding to one image frame capture to be read out while the next image is being formed. An analog-to-digital converter 30 converts the data from the pixels into digital data. A plurality of control registers 40 receives data from a plurality of shadow registers 50, and a plurality of output registers 60 receives data from a plurality of control registers 40; only one of each register 40, 50 and 60 is shown for simplicity. A processor 70 both receives image data from the image sensor 10 via the header and image data bus 80 and separately sends control information to the image sensor 10 via the digital data control bus 90.

Still referring to FIG. 1, a typical operation of the image sensor 10 will now be disclosed hereinbelow. Typically, the image sensor 10, preferably a CMOS sensor, has a control register 40 that is set to a number that corresponds to the length of the exposure. Typically, the processor 70 and image sensor 10 have been operating at some predetermined setting and now the processor 70 determines that the exposure setting is to be changed. First, the processor 70 writes the new exposure setting via the digital data control bus 90 into the digital imager shadow control register 50 for the desired exposure control.

Since the request to modify the exposure setting coming from the processor 70 is asynchronous with respect to the operation of the digital imager 10, the change to the exposure setting must be kept in the shadow register 50 until the digital imager 10 is ready to accept the new setting at which point the exposure setting is transferred to the control register 40 where it will take effect. At the end of a frame capture of the current image, the control registers 40 are transferred to the output registers 60, where they are used as the header portion of the image data and the image pixel values are transferred to the pixel holding sites where they are sequentially read and passed to the analog-to-digital circuitry 30 and digitized and used as the image pixel data portion sent to the processor 70. Substantially simultaneously with this, the shadow registers 50 are transferred to the control registers 40 where they take effect immediately for the next frame capture sequence. It is noted that this above-referenced transfer does not necessarily erase the values of the shadow register 50 as the shadow registers 50 maintain their values until modified via the digital data control bus 90.

At the beginning of an image capture cycle, the shadow registers 50 are shifted into the control registers 40 where they take effect for the next frame capture. Concurrently with this shifting from the shadow registers 50 into the control registers 40, the previous control registers' settings are shifted into the output registers 60. At this point, the control registers 40 will contain the values of the settings to be used for the next frame capture, and the output registers 60 will contain the previous control values that were used for the prior image to be sent onto the image data bus 80.

Meanwhile the processor 70 is reading the continuous stream of digital image frame data being produced by the digital imager 10. Each frame of digital image data produced by the digital imager 10 consists of a header portion of data and image pixel portion of data. The processor 70 reads the header portion of the frame of data and determines from the header if this frame of data is the desired frame. If not, the processor 70 waits for the next complete frame of imager data, reads the header and repeating until the desired frame is detected.

A very common situation exists where the imager registers have been programmed to produce a sequence of low-resolution images for the preview mode of the digital camera. In this mode the sequence of images captured are displayed on a display device on the back of a digital camera. The user uses this display to determine when the subject to be captured is to their liking, at which point the user presses the shutter button on the digital camera to initiate the capture of an image. To capture an image, the imager mode needs to be changed so that it produces and outputs high-resolution images instead of the low-resolution images that were being produced. When the user presses the shutter button, this event is detected by the processor 70 at which point the processor 70 sends the new information to the imager shadow registers 50 to have the imager capture and output a full resolution image. Depending on when this instruction is sent to the imager 10 it is difficult for the processor 70 to know exactly how many images will be received before the setting takes effect. By reading the header portion of each frame of data from the digital imager 10, it is easy for the processor 70 to determine the exact frame at which the data changes from low resolution to high resolution. The processor 70 then uses the high-resolution data to form the captured image without any risk of incorrectly converting a low-resolution image.

It is noted that the header information could alternatively include individually or in combination height, width of the image data and/or strobe setting as those skilled in the art will be able to implement from the above description.

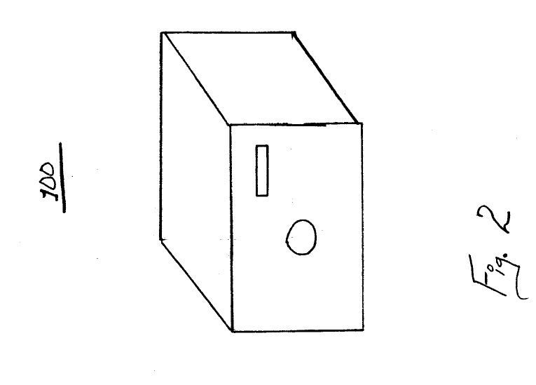

Referring to FIG. 2, there is shown a digital camera 100 for illustrating a typical commercial embodiment for the image sensor 10 and processor 70 of FIG. 1. A digital camera 100 is well known in the art and will not be discussed in detail herein.

The invention has been described with reference to a preferred embodiment. However, it will be appreciated that variations and modifications can be effected by a person of ordinary skill in the art without departing from the scope of the invention.

### Parts List

10 image sensor (digital imager)

20 pixels

30 analog-to-digital converter

40 control registers

50 shadow registers

60 output registers

70 processor

80 image data bus

90 digital data control bus

100 digital camera

What is claimed is:

1. A CMOS sensor comprising:
(a) a plurality of pixels for capturing image pixel data;
(b) an analog-to-digital conversion mechanism for converting pixel data;
(c) one or more first control registers for storing configuration information used for controlling sensor operation;
(d) digital data control bus interface for transporting modified configuration information;
(e) a digital image data bus interface for sending image header data and image pixel data, wherein the image header data is formed from one or more of the first control registers that contain settings that were used in capturing the image pixel data; and
(f) digital circuitry that coordinates with the one or more control registers synchronization between configuration information in the control registers, image pixel data and image header data.

2. The CMOS sensor as in claim 1, wherein the digital circuitry includes:
(g) one or more second control registers for holding pending sensor configuration values from an external source; and
(h) one or more output registers for holding the sensor control settings used for the image currently being output on the image data bus.

3. The CMOS sensor as in claim 2 further comprising:
(i) transfer mechanism for sending the shadow register values to the first control register values at the beginning of an image frame capture cycle; and
(j) transfer mechanism for sending the first control register values to the output registers at the end of each image frame capture cycle.

4. The CMOS sensor as in claim 1, wherein the image header having the information describing characteristics of the image data includes individually or in combination height and/or width of the image data.

5. The CMOS sensor as in claim 1, wherein the image header having the information describing characteristics of the image data includes a strobe setting.

6. The CMOS sensor as in claim 1, wherein the image header having the information describing characteristics of the image data includes individually or in combination height and/or width of the image data and strobe.

7. A digital capture device comprising:
(a) a CMOS sensor comprising:
(i) a plurality of pixels for capturing image data;
(ii) an analog to digital conversion mechanism for converting pixel data;
(iii) one or more first registers for storing configuration information;
(iv) digital data control bus interface for transporting modified configuration information;
(v) a digital image data bus for sending image data and an image header having information that describes characteristics of the image data; and
(vi) digital circuitry that coordinates with the one or more control registers synchronization between configuration information in the control registers, image pixel data and image header data; and
(b) a processor for using the header information to synchronize operation of the digital capture device.

8. The digital capture device as in claim 7, wherein the header information is used to identify a proper frame for capture when switching from a different mode.

9. The digital capture device as in claim 7, wherein the header information is used to identify a proper frame for capture when a strobe setting from the processor is sent to the CMOS sensor.

10. The digital capture device as in claim 7, wherein the header information is used to identify a change in height and/or width of the image data to identify a proper frame for capture.
